(19) United States
(12) Patent Application Publication
(10) Pub. No.: US 2006/0164401 A1
(43) Pub. Date: Jul. 27, 2006

(54) Display device

(75) Inventor: Arichika Ishida, Okegawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA MATSUSHITA DISPLAY TECHNOLOGY CO., LTD., TOKYO (JP)

(21) Appl. No.: 11/316,748

(22) Filed: Dec. 27, 2005

(30) Foreign Application Priority Data
Jan. 25, 2005 (JP) 2005-016794

(51) Int. Cl. G09G 5/00

(52) U.S. Cl. 345/173

(57) ABSTRACT

A display device includes a display panel having a plurality of pixels in a display region, a contact sensing unit which senses contact of an object with a display screen of the display region, photosensors which detect a position of the object and which are placed in the pixels, and a control circuit which causes the photosensors to operate in a case where the contact sensing unit has sensed contact of the object.

### CROSS-REFERENCE TO RELATED APPLICATIONS

This application is based upon and claims the benefit of priority from Japanese Patent Application No. 2005-16794 filed Jan. 25, 2005; the entire contents of which are incorporated herein by reference.

### BACKGROUND OF THE INVENTION

1. Field of the Invention

The present invention relates to a display device provided with an input facility such as a touch panel.

2. Description of the Related Art

In recent years, input facility-equipped display devices, such as liquid crystal display devices, are widely used in which a touch sensor is mounted so that information can be inputted by touching a display screen with a finger or a pen. Such a display device includes a facility capable of sensing contact of an object with a display screen, which is a surface of a display region, and capable of detecting the position coordinates of the object on the display region. It should be noted that various technologies including resistive technology, infrared technology, and ultrasonic surface acoustic wave technology have been proposed and commercialized for use as such input technologies. These technologies will be described below using examples.

In the resistive technology, as illustrated in the cross-sectional view of a display device of FIG. 1, additions 102 are provided on a glass substrate 101 which serves as a base of a display panel. The additions 102 illustrated in the drawing include a flexible film 105, such as a PET sheet, which is approximately 200 □m in thickness and placed to face the glass substrate 101; spacers 103 which are approximately 5 to 10 □m in thickness and placed in a space between a surface of the glass substrate 101 and a surface of the film 105; a laminating agent 104 which is approximately 75 to 200 μm in thickness and provided in order to laminate the glass substrate 101 surface and the film 105 surface to each other; and transparent electrode grids 106a and 106b which are made of an indium-tin oxide (hereinafter referred to as ITO) film having a pattern of orthogonal vertical and horizontal lines and placed on the glass substrate 101 surface and the film 105 surface. Further, voltages are applied to the electrode grids 106a and 106b, in advance.

With the above-described configuration, when a finger 20 as an object comes into contact with the film 105 surface as a display screen, the pressure thereof brings the electrode grid 106a on the glass substrate 101 surface and the electrode grid 106b on the film 105 surface into contact with each other, and allows a current to flow between the electrode grids. Thus, contact of the object with the display screen is sensed. Further, the voltage division ratio between the resistances of the electrode grids on the glass substrate 101 surface and the film 105 surface at this time are measured, whereby the position coordinates of the object on the display screen are detected.

In the infrared technology, infrared light-emitting diodes as light-emitting elements and photodiodes as light-receiving elements are placed in pairs along vertical and horizontal edges around the surface of the display screen. The infrared light-emitting diodes are caused to emit light, and the light is received by the photodiodes. When an object comes close to, or comes into contact with, the display screen and infrared light from the light-emitting diodes is blocked, the photodiodes detect the position coordinates of the object on the display screen by sensing the intensity of light.

In the ultrasonic surface acoustic wave technology, ultrasonic transducers and a reflective array are placed around a display screen, thus causing ultrasonic waves to propagate throughout the display screen. With such a configuration, when an object comes into contact with the display screen, the position coordinates of the object on the display screen are detected by sensing attenuation of ultrasonic vibration.

Further, in recent years, a technology has been proposed in which photosensors are placed in pixels and in which the position coordinates of an object on a display screen are detected based on information concerning the intensities of lights received by the photosensors at the time of input. This technology is described in, for example, Japanese Unexamined Patent Publication No. 2004-153329. In such a technology, whether or not an object has come into contact with the display screen is sensed by a method or the like in which time-series image information obtained by the photosensors, is analyzed.

However, in an input facility-equipped display device employing the resistive technology, additions 102 as illustrated in FIG. 1 must in principle be provided on a display screen of a display panel. Such additions 102 lower the transmittance of light. Thus, display characteristics of a screen are significantly lowered. As a result, there is the problem that the appearance thereof is impaired.

In an input facility-equipped display device employing the infrared technology or the ultrasonic surface acoustic wave technology, though additions on a display screen are unnecessary, the aforementioned optical elements, ultrasonic transducers, or the like are structurally necessary. Accordingly, in both technologies, the display device becomes thick. Moreover, the resolutions of these technologies, when position coordinates are detected, are low compared to that of image display corresponding to pixels. Thus, both technologies have the problem that position alignment for matching a display position to a detection position is necessary.

In an input facility-equipped display device using photosensors, the position coordinates of an object on a display screen are detected by analyzing time-series image information captured by the photosensors at the time of input. Accordingly, there is the problem that the position coordinates of a finger on the display screen are mistakenly detected in the case where the finger makes a move to wonder about, and search for, a position to push on the display screen on which a plurality of options are displayed.

### SUMMARY OF THE INVENTION

An object of the present invention is to provide a thinner display device having excellent display characteristics, does not require position alignment, and prevents a false detection of the position coordinates of an object.

A display device according to the present invention includes a display panel having a plurality of pixels in a display region, a contact sensing unit which senses contact of an object with a display screen of the display region, photosensors which detect a position of the object and which are placed in the pixels, and a control circuit which causes the photosensors to operate in a case where the contact sensing unit has sensed contact of the object.

According to the present invention, the need for additions on or around the display screen and the need to align a display position and a detection position with each other can be eliminated by the photosensors placed in the pixels which detect the position of an object on the display screen.

The position of an object can be prevented from being detected before contact of the object with the display screen by the contact sensing unit being provided independently of the photosensors and by the photosensors detecting the position of the object when the contact sensing unit has sensed contact of the object with the display screen.

It is desirable that the contact sensing unit include a microswitch which performs switching in response to pressure applied by the object from an upper surface of the display screen.

Thus, whether or not an object has come into contact with the display screen of the display panel can be sensed by the switching of the microswitch.

It is desirable that the contact sensing unit include a conductive thin film placed on the display screen, a voltage applying unit which applies a constant voltage to the conductive thin film, and a voltage sensing unit which senses a change in the voltage applied to the conductive thin film due to the object.

Thus, when an object comes into contact with the conductive thin film on the display screen, the voltage of the conductive thin film changes because electric charges accumulated in the conductive thin film leak through the object. A change in the voltage at this time is measured by the voltage sensing unit, whereby whether or not an object has come into contact with the display screen can be sensed.

### BRIEF DESCRIPTION OF THE DRAWINGS

FIG. 1 is a schematic cross-sectional view of an input facility-equipped display device employing resistive technology.

FIG. 2 is a perspective view of a liquid crystal display device to which a first embodiment of the present invention is applied.

FIG. 3 is a cross-sectional view of a region of a liquid crystal display panel of the liquid crystal display device according to the first embodiment, which region corresponds to one pixel.

FIG. 4 is a schematic cross-sectional view of the liquid crystal display device according to the first embodiment.

FIG. 5 is a plan view illustrating an image display example in the liquid crystal display device according to the first embodiment at the time of input.

FIG. 6 is a schematic cross-sectional view of a liquid crystal display device to which a second embodiment of the present invention is applied.

FIG. 7 is a plan view illustrating an image display example in the liquid crystal display device according to the second embodiment at the time of input.

### DESCRIPTION OF THE EMBODIMENTS

Hereinafter, embodiments of the present invention will be described.

### First Embodiment

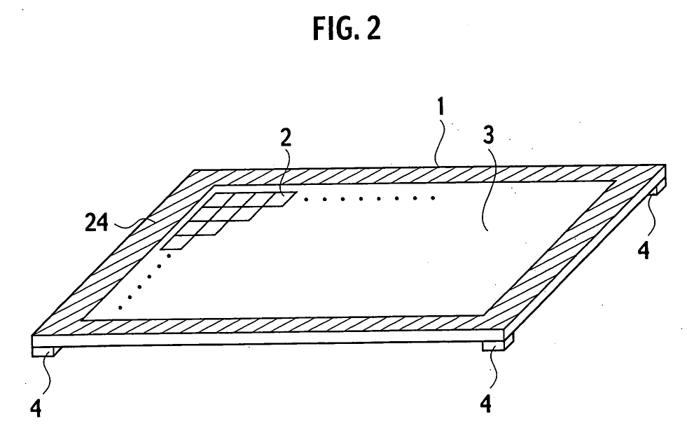

FIG. 2 is a perspective view illustrating a schematic configuration of a liquid crystal display device according to a first embodiment of the present invention. The display device illustrated in the drawing includes a liquid crystal display panel 1, microswitches 4, and photosensors. The liquid crystal display panel 1 has a plurality of pixels 2 in a display region 3. The microswitches 4 are placed at four corners under the liquid crystal display panel 1, and sense contact of an object with a display screen, which is the surface of the liquid crystal display panel 1 in the display region 3. The photosensors are placed in the pixels 2, and detect the position coordinates of the object when the microswitches 4 sense contact of the object.

In the liquid crystal display panel 1, in a region 24 (region diagonally hatched in the drawing) outside of the display region 3, placed are a control circuit which controls the photosensors so that a current is allowed to flow according to the quantity of light incident from the display screen when the object has come into contact with the display screen, a scan line drive circuit which drives scan lines, a signal line drive circuit which drives signal lines, and the like. These are formed in the same substrate by the same process.

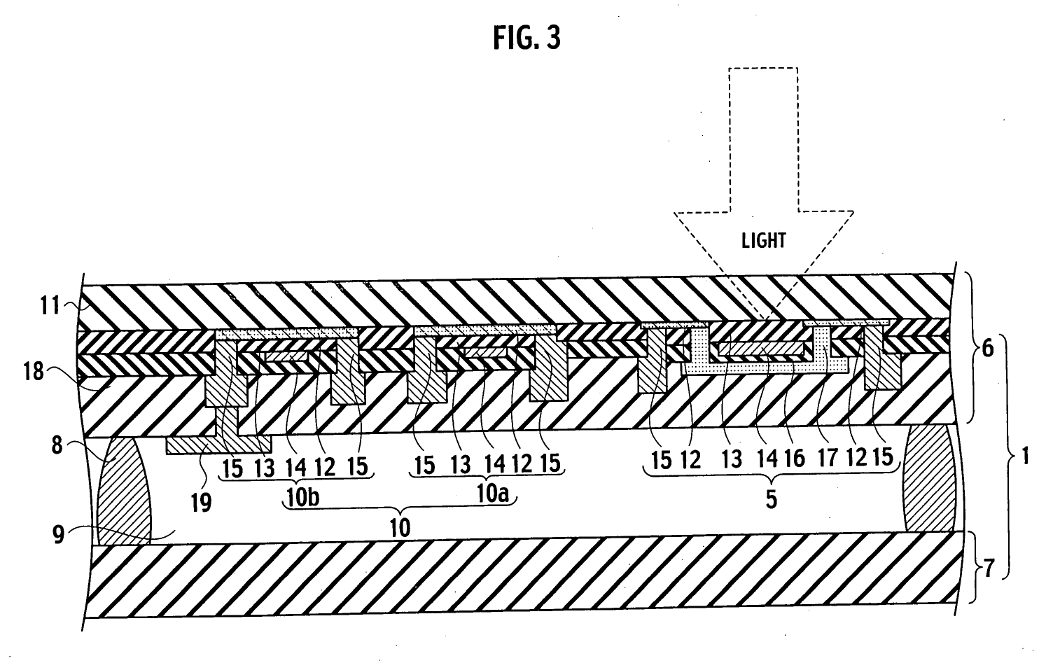

FIG. 3 is a cross-sectional view of a region corresponding to one pixel in the liquid crystal display panel 1 of FIG. 2. In the liquid crystal display panel 1 illustrated in the drawing, an array substrate 6 and a counter substrate 7 are placed with spacers 8 interposed therebetween to face each other. Further, a liquid crystal layer 9 is placed in a space between the array substrate 6 and the counter substrate 7. Moreover, the pixel 2 on the array substrate 6 includes the photosensor 5 which receives light from the outside and converts the light into a current, and thin film transistors 10 for image display. The array substrate 6 including the photosensor 5 is placed on the outer side (upper side in FIG. 3). Thus, light from the outside enters the photosensor 5 without passing through the counter substrate 7 and the liquid crystal layer 9. Accordingly, the photosensor 5 can receive a sufficient quantity of light.

Next, the thin film transistors 10 which are placed in the pixel 2 in order to display an image in the display region 3 will be described using the cross-sectional view of FIG. 3. The thin film transistors 10 here include, for example, an N-type thin film transistor 10a and a P-type thin film transistor 10b. These transistors include source and drain electrodes 15, gate electrodes 14 placed on a gate oxide film 13, a protective film 18 placed thereon, and a pixel electrode 19 for applying a voltage for image display to the liquid crystal layer 9, in a state in which crystalline silicon 12 placed on an insulating glass substrate 11 is used as bases. Here, for example, MoW alloy is used for the gate electrodes 14, and an ITO film is used for the pixel electrode 19. Further, stacked films of Mo/Al/Mo are used for the source and drain electrodes 15.

With the above-described configuration, the thin film transistors 10 placed in each pixel 2 turn on or off the pixel electrode 19 in accordance with directions indicated by a scan signal supplied to the scan line, and thereby applies a voltage for image display, which is supplied to the signal line, to the pixel electrode 19 with appropriate timing, thus displaying an image.

Next, the photosensor 5 which is placed in the pixel 2 in order to detect the position coordinates of the object on the display region 3 will be described using the cross-sectional view of FIG. 3. A photosensor 5 is, for example, placed for each pixel. The photosensor 5 includes source and drain electrodes 15, a gate electrode 14 placed on the gate oxide film 13, an amorphous silicon 17 which is placed on an interlayer insulating film 16 and which is a photosensitive portion for receiving light from the outside, and the protective film 18 placed thereon, in a state in which crystalline silicon 12 placed on the insulating glass substrate 11 is used as a base. Here, for example, MoW alloy is used for the gate electrode 14, and stacked films of Mo/Al/Mo are used for the source and drain electrodes 15.

With the above-described configuration, for example, at the time of input, the display device converts light from the outside which is incident on the photosensitive portion of the photosensor 5 into a current value according to the quantity of the received light. This is performed for all pixels, thus obtaining a pickup image. The display device can detect the position coordinates of the object on the display region 3 without having additions on or around the display region 3 by analyzing the intensity of the incident light from the obtained pickup image.

In the manufacture of the array substrate 6 including the above-described photosensors 5 and the thin film transistors 10, plasma CVD or sputtering is used to form thin films such as the amorphous silicon 17, the gate oxide film 13, the interlayer insulating film 16, and the Mo/Al/Mo stacked films, which are the source and drain electrodes 15. Further, excimer laser light is used to crystallize the crystalline silicon 12. Moreover, boron as P-type impurities or phosphorous as N-type impurities is implanted by ion doping, and annealing is performed in order to activate the impurities.

Next, the microswitches 4 for sensing contact of the object with the display screen of the liquid crystal display panel 1 will be described.

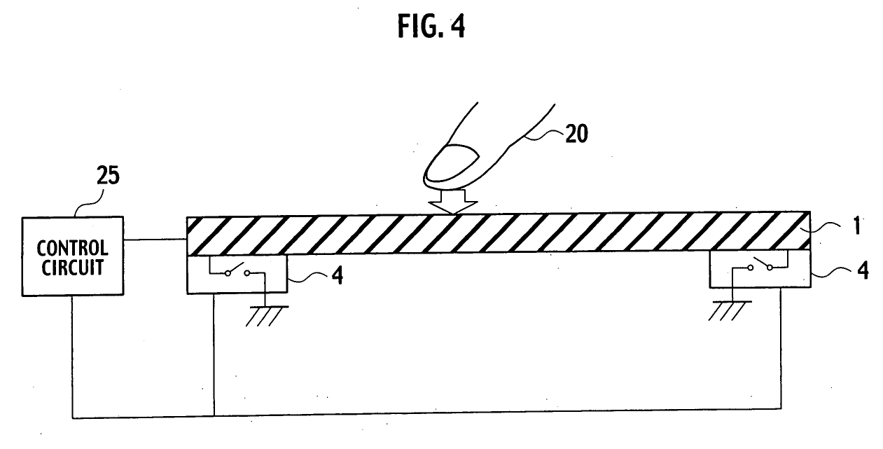

FIG. 4 is a cross-sectional view illustrating the overview of the liquid crystal display device. The liquid crystal display device illustrated in the drawing includes the liquid crystal display panel 1, the microswitches 4, and a control circuit 25. The microswitches 4 are placed, for example, under the liquid crystal display panel 1, and perform switching in response to pressure applied from the upper surface of the display screen, which is the surface of the liquid crystal display panel 1 in the display region 3. Thus, whether or not a human finger 20 as an object has come into contact with the display screen of the liquid crystal display panel 1 can be sensed by the switching of the microswitches 4. Here, for example, the microswitches 4 inform the control circuit 25 for controlling the operation of the photosensors 5 that contact of the object with the display screen has been sensed.

Next, the operation of the liquid crystal display device at the time of input will be described.

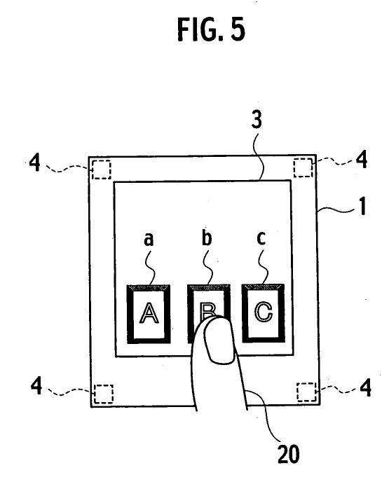

FIG. 5 is a plan view of an image display example in the liquid crystal display device at the time of input. In the liquid crystal display device illustrated in the drawing, in the display region 3 of the liquid crystal display panel 1, for example, alphabetical letters A, B, and C are respectively displayed in three regions a, b, and c on which input is expected to be performed.

When an operator selects region b among three regions a, b, and c and a finger 20 comes into contact with the display screen in region b, contact of the object with the display screen can be sensed by the microswitches 4. At this time, the information that contact of the object with the display screen has been sensed is transmitted from the microswitches 4 to the control circuit 25 for controlling the operation of the photosensors. Then, the control circuit 25 causes the photosensors 5 to start operating. That is, the photosensors 5 placed in the pixels in the display region 3 convert lights incident on the respective regions into currents according to the quantities of the lights synchronously with the timing with which the finger 20 has come into contact with the display screen, thus obtaining a pickup image for each region. The position coordinates of the object on the display region 3 can be detected by analyzing, from the obtained pickup images, light intensities in regions a, b, and c on the display region 3.

Accordingly, in the first embodiment, the need for additions on or around the display region 3 can be eliminated by the photosensors 5 placed in the pixels 2 detecting the position coordinates of an object on the display region 3. The need to align a display position and a detection position with each other can be eliminated.

In the first embodiment, the microswitches 4 for sensing whether or not an object has come into contact with the display screen of the display region 3 are provided under the liquid crystal display panel 1. When the microswitches 4 sense contact of an object with the display screen, the photosensors 5 detect the position coordinates of the object. Thus, the position coordinates are not detected before the object comes into contact with the display screen. Accordingly, a false detection of the position coordinates can be prevented.

The first embodiment is excellent in display characteristics and thinner, does not require position alignment, and can prevent a false detection of the position coordinates of an object.

It should be noted that though the first embodiment has a configuration in which four microswitches 4 for sensing contact of an object with the display screen are placed at four corners under the liquid crystal display panel 1, the present invention is not limited to this. For example, a configuration in which one microswitch 4 is placed at one corner out of four corners may be adopted as long as whether or not an object such as a finger 20 has come into contact with the display screen of the display panel can be sensed by the switching of the microswitch 4.

Furthermore, though the first embodiment has a configuration in which the microswitches 4 for sensing contact of an object with the display screen are placed under the liquid crystal display panel 1, the present invention is not limited to this. For example, in electronic instruments such as mobile phones which require robustness, a surface-treated protective plate made of acrylic resin is placed on a display screen of a display device in order to protect the display screen from mechanical stress. A configuration may be adopted in which microswitches 4 are placed under such a protective plate.

### Second Embodiment

Hereinafter, a second embodiment will be described. A display device according to the second embodiment has the same basic configuration as the display device of the first embodiment, but differs from the display device of the first embodiment in the following points: the display device of the second embodiment employs a conductive thin film placed on the display screen of the display panel, a power supply unit for applying a constant voltage to the conductive thin film, and a voltage change sensor for sensing a change in the voltage applied to the conductive thin film due to the object, in order to sense contact of the object with the display screen, without adopting microswitches.

The conductive thin film, the power supply unit, and the voltage change sensor will be described below.

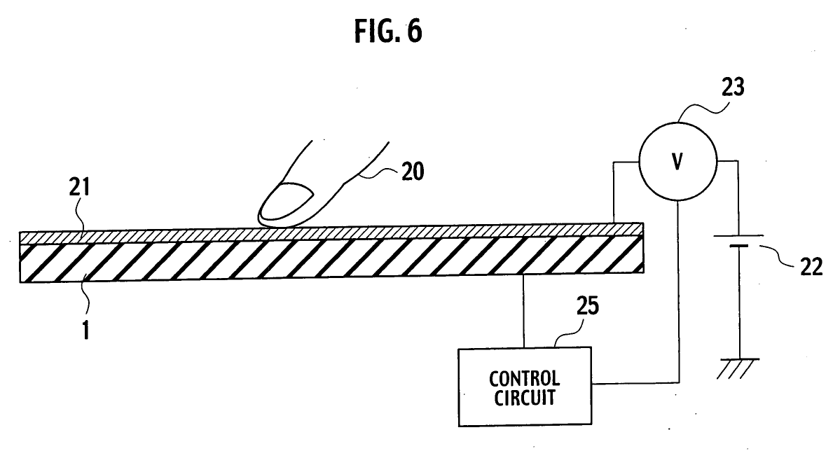

FIG. 6 is a cross-sectional view illustrating the overview of the liquid crystal display device. The liquid crystal display device illustrated in the drawing includes the liquid crystal display panel 1; the conductive thin film 21 placed on the display screen, which is the surface of the liquid crystal display panel 1 in the display region 3; the power supply unit 22 electrically connected to the conductive thin film 21, the voltage change sensor 23, and the control circuit 25. The power supply unit 22 applies a constant voltage to the conductive thin film 21 in advance. The voltage change sensor 23 senses a change in the voltage applied to the conductive thin film 21. Here, for example, a transparent ITO film is used for the conductive thin film 21 in consideration of influence on display characteristics. Further, the power supply unit 22 and the voltage change sensor 23 are provided as external integrated circuits (ICs) electrically connected to the conductive thin film 21.

With the above-described configuration, when a finger 20 comes into contact with the conductive thin film 21 on the display screen, electric charges accumulated in the conductive thin film 21 leak through the finger 20. This causes a change in the voltage at an edge of the liquid crystal display panel 1. The change in the voltage at this time is measured by the voltage change sensor 23, whereby whether or not the finger 20 has come into contact with the display screen of the liquid crystal display panel 1 can be sensed. At this time, for example, the voltage change sensor 23 informs the control circuit 25 for controlling the operation of the photosensors that contact of an object has been sensed.

Next, the operation of the liquid crystal display device at the time of input will be described.

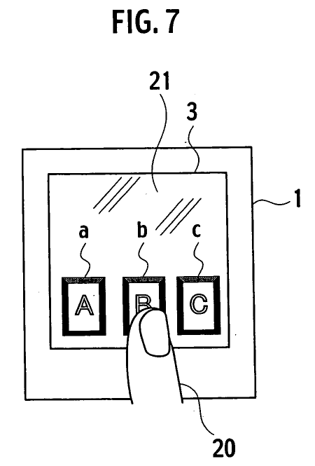

FIG. 7 is a plan view of an image display example in the liquid crystal display device at the time of input. In the liquid crystal display device illustrated in the drawing, in the display region 3 of the liquid crystal display panel 1, for example, alphabetical letters A, B, and C are respectively displayed in three regions a, b, and c on which input is expected to be performed. Here, since a transparent ITO film is used for the conductive thin film 21, there is no influence on display characteristics. Further, as described in FIG. 6, the power supply unit 22 for applying a constant voltage in advance and the voltage change sensor 23 for sensing a change in the voltage applied to the conductive thin film 21 are assumed to be placed as external ICs on the outside of the liquid crystal display panel 1.

When an operator selects region b among three regions a, b, and c and a finger 20 comes into contact with the conductive thin film 21 on the display screen in region b, the voltage change sensor 23 senses contact of the object with the display screen. At this time, the information that contact of the object has been sensed is transmitted from the voltage change sensor 23 to the control circuit 25 for controlling the operation of the photosensors 5. Then, the control circuit 25 causes the photosensors to start operating. That is, the photosensors 5 placed in the pixels in the display region 3 convert lights incident on the respective regions into currents according to the quantities of the lights synchronously with the timing with which the finger 20 has come into contact with the display screen, thus obtaining pickup images. The position coordinates of the object on the display region 3 can be detected by analyzing, from the obtained pickup images, light intensities in regions a, b, and c on the display region 3.

The above-described second embodiment includes the conductive thin film 21 placed on the display screen of the display region 3 of the liquid crystal display panel 1, the power supply unit 22 for applying a constant voltage to the conductive thin film 21 in advance, and the voltage change sensor 23 for sensing a change in the voltage applied to the conductive thin film 21. Thus, when a finger 20 comes into contact with the conductive thin film 21 on the display screen, electric charges accumulated in the conductive thin film 21 leak through the finger 20. This causes a change in the voltage at an edge of the liquid crystal display panel 1. The change in the voltage at this time is measured by the voltage change sensor 23, whereby whether or not the finger 20 has come into contact with the display screen of the liquid crystal display panel 1 can be sensed.

The second embodiment is excellent in display characteristics and thinner, does not require position alignment, and can prevent a false detection of the position coordinates of an object.

It should be noted that though a transparent ITO film having little effect on display characteristics is used as the conductive thin film 21 in the second embodiment, the present invention is not limited to this. Any thin film may be used as the conductive thin film 21 as long as it is made of a high-conductivity material which can sufficiently accumulate electric charges without deteriorating display characteristics.

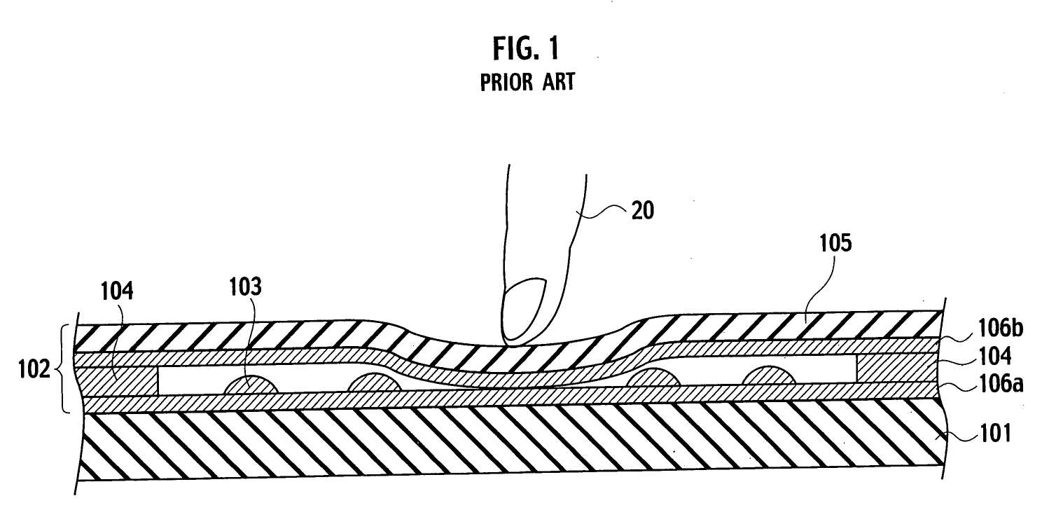

In the second embodiment, the power supply unit 22 which is electrically connected to the conductive thin film 21 and which applies a constant voltage to the conductive thin film 21 in advance is an external IC. However, the present invention is not limited to this. A power supply circuit capable of supplying a voltage to the conductive thin film 21 may be provided as the power supply unit 22 in the same substrate as the drive circuits and the like in a region (e.g., the diagonally hatched region 24 of FIG. 1) of the liquid crystal display panel 1 outside of the display region 3 to be integrated into the substrate. Moreover, this power supply circuit may have a configuration which enables the supply of a power supply voltage for driving the drive circuits and the like integrated into the same substrate.

Also, though the voltage change sensor 23 which is electrically connected to the conductive thin film 21 and which senses a change in the voltage applied to the conductive thin film 21 is an external IC in the second embodiment, the present invention is not limited to this. A comparator circuit which compares the magnitude of a preset reference voltage and that of an input voltage to output the result may be provided as the voltage change sensor 23 in the same substrate as the drive circuits and the like in a region (e.g., the diagonally hatched region 24 of FIG. 1) of the liquid crystal display panel 1 outside of the display region 3 to be integrated into the substrate. That is, a configuration may be adopted in which a change in the voltage applied to the conductive thin film 21 is sensed using the comparator circuit.

In the aforementioned first and second embodiments, a photosensor 5 for detecting the position of an object is provided for each pixel. However, the present invention is not limited to this. One photosensor 5 may be provided for a plurality of pixels. For example, a configuration may be adopted in which one photosensor is provided for three pixels of R, G, and B.

In the aforementioned first and second embodiments, a liquid crystal display device has been described as an example. However, the present invention is not limited to this. In the case of a display device in which photosensors 5 can be placed in pixels, a configuration can be adopted in which a contact sensing unit which senses contact of an object with the display screen is provided and in which the position coordinates of the object are detected by the photosensors 5 synchronously with the timing of contact of the object with the display screen. Thus, the present invention also covers a display device which employs other technology, e.g., an organic EL display, a plasma display, or a field emission display (FED).

What is claimed is:

1. A display device comprising:
a display panel which has a plurality of pixels in a display region;
a contact sensing unit which senses contact of an object with a display screen of the display region;
photosensors which detect a position of the object, the photosensors being placed in the pixels; and
a control circuit which causes the photosensors to operate in a case where the contact sensing unit has sensed contact of the object.

2. The display device of claim 1, wherein the contact sensing unit includes a microswitch which performs switching in response to pressure applied by the object from an upper surface of the display screen.

3. The display device of claim 1, wherein the contact sensing unit includes:
a conductive thin film placed on the display screen;
a voltage applying unit which applies a constant voltage to the conductive thin film; and
a voltage sensing unit which senses a change in the voltage applied to the conductive thin film due to the object.
